(19) United States
(12) Patent Application Publication
(10) Pub. No.: US 2016/0204853 A1
(43) Pub. Date: Jul. 14, 2016

(54) SYSTEM AND METHOD FOR SATELLITE ROUTING OF DATA

(71) Applicant: LEOSAT, LLC, Pompano Beach, FL (US)

(72) Inventors: Cliff Anders, Pompano Beach, FL (US); Seacol Chin, Sugar Land, TX (US)

(21) Appl. No.: 14/961,555

(22) Filed: Dec. 7, 2015

Related U.S. Application Data
(63) Continuation-in-part of application No. 14/713,590, filed on May 15, 2015.
(60) Provisional application No. 61/993,758, filed on May 15, 2014.

(51) Int. Cl. H04B 7/185

(52) U.S. Cl. CPC H04B 7/18584

(57) ABSTRACT

We disclose herein a system and method for routing data between satellites in orbit and clients located on earth. The system provides high-throughput method for moving data on and off of satellites. The satellites have onboard processors to manage the network and dynamically switch between gateway and client based modes.

### CROSS-REFERENCES TO RELATED APPLICATIONS

This application is related to application U.S. patent application Ser. No. 14/713,590, filed on May 15, 2015, which claims benefit of priority to U.S. Provisional Application Ser. No. 61/993,758, filed May 15, 2014, which are hereby incorporated by reference herein in their entirety.

### FIELD OF THE INVENTION

The present invention is generally directed toward a system for providing high speed network connections globally. More particularly, it discloses a method for routing data between satellites and the ground based networks.

### BACKGROUND OF THE INVENTION

LeoSat has come to this market with the specific goal of applying new and emerging technologies to the Satellite Data Market. We are a forward-looking company with an engineering history of developing and providing data/voice communication in harsh environments.

We strongly believe that it is time for a market shift in satellite data communications. Technology developments and demands have lined up to facilitate a major shift in how satellite data is viewed and delivered. While the market has many long-established companies, there is a tendency as in most long time operators, to continue to look at the market with the way “things have always been done.” Both existing and potential new customers to this market are being driven by the ever expanding growth in the need to stay connected to the Internet with high-performance connections everywhere. Many customers are being held back by the current offerings which miss on both price and performance. Cruise ships cannot begin to keep up with their passenger's demand of always on high-speed Internet services. Oil exploration and production need much faster data transport than is available today. The developing world needs cost effective high-performance networks for telemedicine and distance learning. Widely dispersed countries like Indonesia, Canada, parts of China, Africa, South America and the Soviet Union need cost effective high-speed networks to help these areas develop. When disaster strikes such as earthquakes, hurricanes or a tsunami rescue and relief efforts need to be able quickly establish solid communications and data networks. Finally, there is a demand for a worldwide truly secure data network solution. Current operators providing 1-2 Mbs (even 12 Mbs in limited cases) at high costs are not up to the challenges of these demands. Most require 7-9 foot dishes for marginally high speed access. These antennas must be set in concrete to maintain focus on a satellite some 22,500 miles out in space. Even then the performance of these systems is poor. Twelve (12) megabits on such as a system performs like 0.5 megabits on a normal network. This is not nearly enough for the demands. The equipment is expensive, large and the data performs poorly. The cost of the data is still very high and in the quantities needed, simply not available.

How we See the Market Today

We see the satellite data markets as being ill-served today. There are some new advances in satellite services being offered, but they are just incremental improvements over the past generations of offerings. Many of the same major problems with the older systems, still exist in the new offerings. Additionally, these problems are going to have even more negative effects in the future.

Problems with the Current Systems

Latency

Latency (delay) is partly a factor of physics and partly a factor of design. It is not just a problem with having a delay in telephone calls transmitted over the links; it is a problem with data transfers, applications and even web browsing. It is a problem that will continue to cause increasing frustration with the use of such connections for access to the Internet. The backbone and the connection speeds on the Internet are all increasing at exponential rates. As more devices and people are connected, more speed, efficiency and bandwidth are required. Websites and other such portals are optimized to serve as many clients as possible, as efficiently as possible. Administrators make tradeoffs in their methods of identifying efficiency models for their servers. When a client connects to a website and makes a request, a data socket is established. The server services these sockets in pools. If a particular client is taking more than XX ms to respond, the server will terminate that connection and hope the client comes back with a better connection. The servers simply can't wait on slow connections and stay efficient. The “delay timeout” settings have been lowered and will continue to be lowered as statistically the connection speeds increase. Another cause of dropped connections is a client that requires a lot of retransmission of the data packets. Again, the server will identify these connections and drop them, hoping the client will return with a better connection. To put this in the specifics of the GEO Satellite serviced client, a connection with a round trip delay of 500 ms will see increasing performance degradation in the future. Latency has a terrible performance impact on any TCP/IP network.

Performance

Latency drives performance on a data network. TCP/IP is the transport for today's data networks, and due to the methods used in this transport latency or delay (for the purposes of this discussion the terms are interchangeable) are major factors in actual performance. When a service provider sells a client a megabit rate, the actual throughput on that bandwidth will be significantly impacted by the satellite system being used. Most satellites providing the services today are in a GEO orbit level. This level is approximately 36,000 Km (22,500 miles) above the earth. There are some new systems coming on line that are in MEO orbit which is approximately 8,500 Km (5,200 miles). However, as you can see in attachment “A”, neither system will provide for the systems necessary to keep up in the coming years. For reference a GEO system promising 50 Mbs bandwidth will actually only provide 1 Mbs of actual throughput when using a TCP/IP connection. The type connection all Internet browsing uses today.

RTT 10 ms=>TCP throughput=52428000 bps=52 Mbps
RTT 20 ms=>TCP throughput=26214000 bps=26 Mbps
RTT 50 ms=>TCP throughput=10485600 bps=10 Mbps
RTT 100 ms=>TCP throughput=5242800 bps=5.2 Mbps MEO Best Performance
RTT 150 ms=>TCP throughput=3495200 bps=4.3 Mbps
RTT 200 ms=>TCP throughput=2621400 bps=2.5 Mbps
RTT 300 ms=>TCP throughput=1747600 bps=1.7 Mbps
RTT 500 ms=>TCP throughput=1048560 bps=1 Mbps GEO Best Performance

There are WAN accelerators (such as Riverbed Steelhead) that use caching and sliding frame sizes to help improve the throughput, but they can't change the physics of the time it takes the radio signal to traverse the distances.

Coverage

There is not a system today that can provide the same level of high speed Internet connections throughout the world. There are both GEO and MEO systems that provide coverage for locations to approximately 35-45° North or South of the equator. The further from the equator one travels the slower the speed will become and the quality of the connection will suffer as well. While some operators in the market place are claiming “worldwide coverage”, the fine print reads that the system will revert to lower frequency bands (very slow speed) in and/or low bandwidth connections farther reaches of their system coverage areas. No system today provides the same high speed data worldwide.

Mechanical Dishes

For clients that move e.g. maritime, vehicles, Airplanes tracking dishes (or very expensive and power hungry phased array antennas) must be used to keep the dishes pointed to the satellite for service. The dishes require 3 axis stabilized platforms that are continuously operating motors and gears or belts, to keep the beam accurately pointed at its servicing satellite. Therefore, there are numerous moving parts that are subject to wear and failure over the life of the system. Such systems require significant preventative maintenance checks and part replacements. This requires vendor visits to just about anywhere in the world to replace a belt, motor or BUC, that has failed while in service. This drives costs, operational outages and therefore loss revenues. It increases costs to the operator and causes increased costs to the clients as well. These solutions have proven difficult to maintain to a level that complies with SLA's.

Client Station Costs

The current satellite client station costs for high capacity users are substantial ($100K+). The cost of installing, maintaining and changing the client stations is a significant factor in the total cost of operation of the satellite Internet data. If a MEO or LEO system is used, the client station requires at least two tracking dishes and for redundancy a third should be installed.

The problems with the prior art indicate that there is a need for a new communication system for providing global network access. We disclose herein a system and method for transmitting data that employs new the satellite payloads, new data treatment methods, new data routing methods and new client terminals, and new technologies that significantly change the paradigm of what can be delivered and at what cost.

### SUMMARY OF THE INVENTION

We looked at this market and decided a new approach was timely. New technologies can be brought to the market, the demand is going nowhere but up and the entrenched players have huge invested interest to not obsolete themselves too rapidly.

### BRIEF DESCRIPTION OF THE DRAWINGS

Further advantages of the invention will become apparent by reference to the detailed description of preferred embodiments when considered in conjunction with the drawings:

FIG. 1 illustrates the LEOSAT satellite configuration of a 64 low earth orbit satellite system.

FIG. 2 illustrates satellite orbital areas of LEO (Low Earth Orbit), MEO (Medium Earth Orbit), and GEO (Geosynchronous Earth Orbit).

FIG. 3 illustrates a bent pipe architecture.

FIG. 4 illustrates a grid of fixed spot beams for a constellation of MEO satellites.

FIG. 5 illustrates a constellation of satellites with spot beams in equatorial orbit.

FIG. 6 illustrates a fixed spot beam from a satellite.

FIG. 7 illustrates a constellation of LEO satellites.

FIG. 8 illustrates a map showing multiple connections and frequencies available to a ship from land-based connections.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

We built the disclosed system from the ground up, instead of from the satellite down. This meant we attacked the issues with the client stations first. Considerations were size, profile, redundancy, flexibility, reliability and cost. In a first embodiment, we specially designed a client station antenna for large users as described herein:
Size: 40 inches×40 inches×4 inches (L×W×H)×2 (one transmit and one receive)
Profile: Mounts flat on flat surface with 4 inch wind profile
Redundancy: Two independent systems that work in parallel with both active at all times.
   Each has the ability to engage multiple satellites simultaneously.
   Either one can provide the full bandwidth purchased.
Flexibility: Supports multiple data protocols and coding schemes. Such as TCP/IP and DBV-x. Ability to track multiple satellites at the same time.
Reliability: No motors, belts, gears or even BUC's. Simply no moving parts.
Cost: <$50K
Capacity: Up to 2 Gbs per beam. Multiple beams available.

The antenna provides significant advantages over other client station antennas, in that it has a high capacity, and is significantly less expensive than arrays or other antennas that are typically used. Furthermore, it has a low wind provide and can engage multiple satellites simultaneously. The antennas are two independent systems that work in parallel to provide redundancy.

We then attacked the issues with performance and cost per megabit. The system is designed with the following specifications, but it should be appreciated that this is just one working embodiment, and that variations and alternatives are within the scope of this disclosure.

Latency

Understanding that latency is the biggest factor in performance (other than raw bandwidth) we designed the system with a latency factor of <50 ms. This provides for a level of performance that will not only exceed today's requirements, but also be in line to perform well with the Internet and systems for many years into the future. Low latency is achieved by using a low orbit of 1000 miles instead of 22,000 miles typically used by other MEO or GEO communication satellites.

Performance

Having addressed the latency issue, our system will outperform a GEO system by a factor of 50 to 1. It will outperform a MEO System by a factor of 10 to 1. This is directly related to costs as well. The performance difference means that a customer would have to contract for a high multiple of bandwidth from one of the other systems to receive the same user experience of a much lower bandwidth rate from our system. One other significant difference in our system and the current systems is that our service offers synchronous bandwidth. Our upload speeds are the same as our download speeds. This will make a huge difference in the ability of the clients to maintain servers, email and video across these connections. This will also be a welcome benefit to mobile operators such as Cruise lines with their administrative data needs and oil field exploration with their collected data uploads and real time video monitoring of remote areas.

In summary, LeoSat will be the first company to offer a unique combination of lowest latency, actually usable high speeds at very attractive prices and truly global reach. The ability of the satellite to off load the entire capacity of the maximum client links via the ISL's is extremely important as it goes to flexibility, avoiding satellite saturation and being able to use remote gateways to serve difficult areas.

Pricing

We have designed the system to allow our purchase of our core bandwidth from strategically located locations where there is heavy competition by large Internet backbone providers. Using the competition between the backbone providers we will have access to the lowest pricing in the market.

The flexibility we built into our design allows for our being able to have our core locations compete even with each other for the lowest cost of Internet backbone. Our pricing to the clients will be based upon a bandwidth committed information rate (CIR) with no monthly usage caps or other added costs. Therefore, continuous use will not be a problem. Bandwidth usage will be monitored and recorded with usage statistics available at any time. If a client is hitting its maximum bandwidth level, additional bandwidth can be increased as needed to meet demand. We will even offer programs where the bandwidth can be adjusted on a schedule of high season and low season. It should be appreciated that our design does not require our “adding a transponder” or any other such ceilings. Our design is delivery by software settings in the client that can be changed remotely. No additional equipment and no site visit required.

Coverage

The coverage will truly be worldwide. We will be able to deliver the same quality and quantity of bandwidth to any client regardless of their location. Such large covered is accomplished by using 64 satellites in overlapping orbit patterns that are able to communicate with each other. In one embodiment, the pattern of orbits of satellites can be described as a duel rosetta to ensure overlapping coverage.

No Mechanical Dishes

As described earlier our client antennas have no moving parts and no parts to change. If one fails there is already a redundant one running that can deliver the complete bandwidth. Additionally in the event of a failure a change out is extremely simple. There is no real “pointing” of the antenna, just detach and replace.

Client Station Costs

We have targeted our highest bandwidth client station to cost less than $40 k with full redundancy. Other portable and small client stations without redundancy are expected to cost approximately $20 K. These costs are significantly lower than other satellite communication providers.

Redundancy

The new system is fully redundant. The antennas are redundant, the radios and all supporting equipment is installed with redundancy in place.

Meeting Client Requirements

The client experience with the new system will be very much like their experience with Internet usage in terrestrial networks. The performance will be on par with telecom provided connections to offices. “Always on” connections.

### System Comparison

| Operation Aspects | GEO | | MEO | | IT Centricity | |
|---|---|---|---|---|---|---|
| Latency | 500 | ms | 130 | ms | 50 | ms |
| IP Performance @ | 1 | Mbs | 1.7 | Mbs | 37 | Mbs |

| | | | |
|---|---|---|---|
| 50 Mbs | | | |
| Pricing | $750+ per | $800+ per | $800 per |
| | Hz/Mbs | Hz/Mbs | Hz/Mbs (est.) |
| Coverage | 35° to 45° of | 35° to 45° of | Worldwide |
| | equator | equator | |
| Mechanical Dish | 1 or 2 | 2 minimum | None |
| Client Station Cost | $150,000+ | $450,000+ | <$50,000 |
| Redundancy | Fall back to Ku | Not fully | Fully redundant |
| | band | redundant | |
| Sold by | Bandwidth + | Bandwidth + | Bandwidth |
| | Caps | Caps | no caps |

The comparison chart fails to capture some of the benefits of the currently described system over the current systems. The ability of the clients to enjoy an always on connection and equal upload speeds should not go un-noticed. The performance differences are not just important today, but will become increasingly important in the future as everything speeds up. Current systems with a significant latency issue is a growing problem that will only become worst with time.

It should be appreciated that the disclosed invention can have many different applications, including, but not limited to, the following:
1) Maritime, including but not limited to Cruise Lines, commercial shipping, Ferries and possible military contracts.
2) Oil Exploration and production. Both on-shore and off-shore.
3) Island Nations—Schools, telemedicine, remote location government services and feed for ground internet providers.
4) Extreme Northern and Southern regions that lack a business case for fiber and are not served by current satellite solutions.
5) All clients that currently use satellite, but need symmetric or high rate “up” bandwidth. News media and any organization that produces large data in remote places.
6) All clients where real time remote operation or monitoring of equipment in remote locations is necessary.
7) Emergency response teams worldwide. A complete client station that will have the ability to deliver a true high speed backbone network anywhere in the world. The client station will weigh less than 200 lbs and will require less than 800 watts of power. Both phone and data services will be established over a common link.
8) Business clients that require the most secure commercial network connectivity in the world.
9) Island nations seeking high speed backbone connectivity for their services.

It should also be appreciated that the disclosed invention provides the following advantages over the prior art:
1) The system uses the high speed and large bandwidth of the Ka band to a LEO system. KA band is high frequency which is more susceptible to moisture.
2) Networking a constellation of satellites together with high throughput data capabilities using low latency routing techniques.
3) Due to system design we will be able to place ground stations in the most beneficial economical locations for wholesale Internet bandwidth purchases, for example at internet backbones.
4) Significantly reducing latency and thereby significantly increasing bandwidth performance.
5) Introducing a new client station design that will address many of the problems with the existing client stations. (e.g. Size, maintenance, moving parts, power requirements)
6) The first and only true worldwide total wideband high throughput commercial satellite system deployed.
7) The most secure encrypted client to encrypted client non-military data network in the world. Because the system employs the use of protocol independent transport (Multiprotocol Label Switching (MPLS)), it can securely transmit multiple data feeds without compromising security.
8) The first high bandwidth many in the far north/south and middle of the ocean will see. Bandwidth up to 1.2 Gbs.
9) Any client station can also be a gateway.
10) First MPLS network in space.

The Technical Details

Satellite Routing

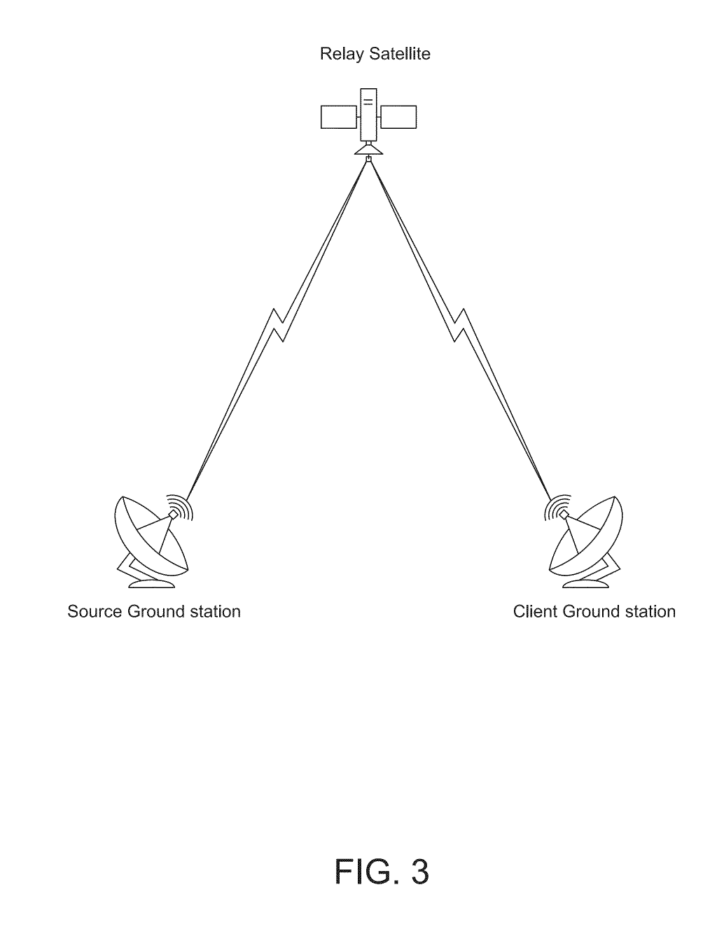

FIG. 3 illustrates the “Bent Pipe” architecture used in the vast majority of all satellite deployments of the prior art. This is where the satellite is nothing more from a routing perspective than a relay. The data is sent to the satellite from the client, only to be retransmitted back down to a gateway attached to the Internet or private network. There has been little to no processing as far as routing is concerned on the satellites.

Recently there have been some deployments of what the satellite industry terms a “mesh” network. This enables client stations on the same satellite to send data directly to each other. This was accomplished with the routing devices being placed at the client stations and still using the satellite as a relay. However, there is no facilitation for clients not on the same satellite.

The only other routing that is currently taking place on commercial satellites is being done on the Iridium system. The Iridium system is very much like a cellular phone system, just in the sky. It routes cellular phone calls from the user's handset to the nearest gateway via Inter-Satellite Links (ISL's). It also routes very small data using the same methodology. The Iridium system is limited to routing their data (calls) in the same methods that cellular calls are routed on land based systems.

Other prior known methods don't actually transmit at advertised rates. For example, O3B claims that it transmits 84 Gbs but really only transmits at 19.2 Gbs because the data is not really being routed.

Some of the newest and most advanced deployments of satellite systems suffer from the inability of moving their customers data off their satellites. The case in point is O3B. While they claim throughput of 84 Gbs on their 8 satellite constellation, they actually only have a maximum throughput of 19.2 Gbs. The O3B satellites each have 10 customer beams and 2 gateway beams. While the customer beams could max out at 10×1.2 Gbs=12 Gbs each satellite, they can only get 2×1.2 Gbs=2.4 Gbs of that to their gateways. So the real throughput is only 2.4 Gbs per satellite. Or stated another way, a maximum of 2.4 Gbs available per ⅛^{th} of the earth. It is important to note that O3B is not alone in claiming the sum of their client beams as their satellite “throughput”. Much to our dismay it is widely done in the industry.

We recognized during the design phase of their new system that a new approach to data movement on and off satellites was necessary because the prior art methods were unable to achieve the high-throughput required.

The method disclosed herein takes a different approach with each satellite having the same number of client facing beams, but incorporating four (4) Inter-Satellite Links (ISL's) per satellite and implementing a fully managed intelligent meshed network between the satellites, gateways and clients. Prior art satellites do not have any real processing capabilities. Incorporating such processing abilities adds significant power requirements, weights, and other constraints, but is done to maximize performance of the network. The four (4) ISL's would be one to the satellite in front, one to the rear, one to the left and one to the right. The ISL's would preferably utilize a higher frequency providing for larger bandwidth transfers between the satellites. In a preferred embodiment, that link between satellites (which are about 1500 to 1600 miles apart) is a 40 GHz link.

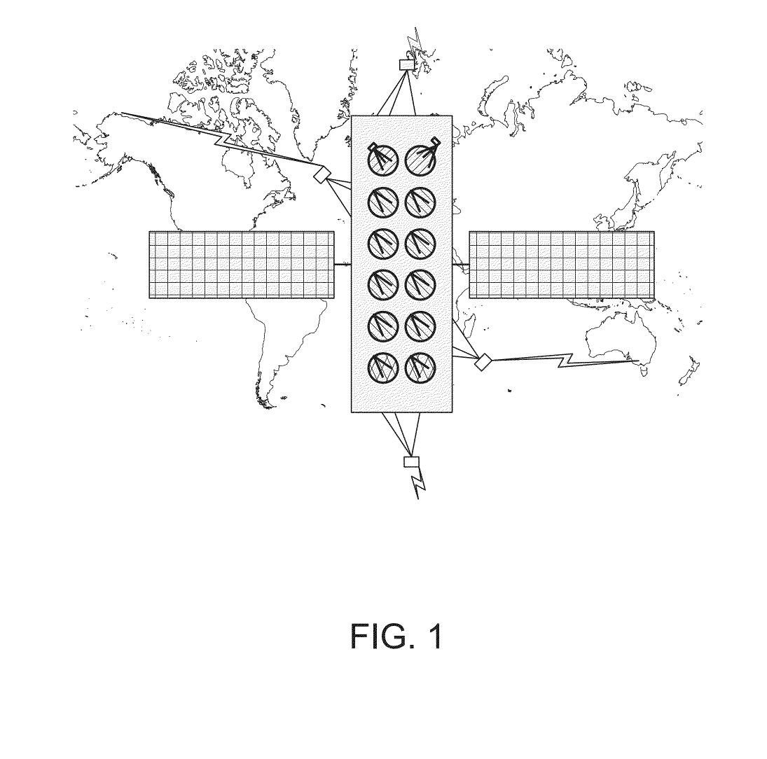

One unique aspect of our system (see FIGS. 1 & 7) is that each of our client beams can be configured dynamically as a client and/or gateway through software. Prior art systems were incapable of switching dynamically between gateway and client mode where the satellite meets the earth network. As a result, the system can allocate resources as needed to reduce any bottlenecks to earth. The gateways can be activated and deactivated as demand dictates.

In one embodiment, MPLS is used as the data transport protocol. By using MPLS we are able to create end-to-end circuits across any of our links. MPLS also allows the network to support circuit-based clients and packet-switching clients on the same network at the same time. So a bank, for example, can have a separate private network with its branches and ATMs instead of using the internet. At this time MPLS would appear to be a good candidate for the transport logic, however other transport protocols may also be used.

The processors on board the satellite are used to help manage the network. In a preferred embodiment, the network will be rules-based on a “cost scoring” method. The cost scoring can be weighted by latency, bandwidth costs at gateways, regional restrictions, hop counts and any number of other factors. Network management will normally be automatic, however it can be temporarily modified by network operators to work around issues or problems. The networking will have a “failsafe” mechanism that would allow all tables to be reset or cleared in the event of a malfunction. Copies of the tables would be routinely backed up to the gateways and on the satellites themselves.

While we recognize that there is concern with having critical processing taking place on the satellites, we are incorporating several failsafe techniques into the design to insure our control of the processing.

This system provides the dynamic flexibility of data transport that has come to be expected of professionally managed networks. With the ability to guarantee bandwidth, performance and security, this satellite network will set a new standard in how data is transported and handled by a satellite network. The enormous flexibility will enable operations to develop feature sets attractive to the client's needs for years to come, while also keeping costs well under control.

### Examples of Usage

If an oil exploration company in the Gulf of Mexico wants to institute new real time measurements and controls on their rig operations and monitor/control them from Houston, we can provide this with direct rig to headquarters links. Completely secure, no gateway needed.

If cruise operators would like to go to cloud management of their fleets and hotel services, we can not only network them all together into a high performance cloud, but also provide peering services with all parties. Completely secure, no gateway needed.

If an international bank wants completely secure connections to certain other bank operations around the world, we can provide that. Completely secure, no gateway needed.

If an Island nation wants to link their remote islands for government services, telemedicine, communications, schools and even video, we can supply that connectivity at a very reasonable cost.

The Internet on Cruise Ships is at best, slow and at worst, unusable. While there are several competing solutions “on the horizon,” only one appears to be a viable candidate to bring the systems to a performance level that will meet today's and tomorrow's demand. Explained with some detail below is how each announced system will strive to address the requirements. Also explained is what can be done to make the most of today's options and what is coming to a cruise ship that will finally meet the demands.

First, let's set some standards and expectations. Cruise ships are concentrated connections, and a group of cruise ships will overload a bandwidth that is not dedicated. You simply cannot put several cruise ships on a shared bandwidth link and expect the performance to be acceptable. The Bahamas/Caribbean areas of cruising only spread across two time zones and ship schedules are very close to the same on each ship. There is usually a 6 PM first seating and an 8:30 PM second seating for dinner. Shows and other planned activities on ships are also very much in line across the ships. Even port times are close. What this creates is peak time for Internet usage that is relatively consistent across ships in the region. All of this also influences Internet usage by the crew and the administration, as their activities are driven by the identical schedules. So there is a high concentration of users on a ship and then have multiples of high concentrations of users across ships, with a concentrated use during identical time periods. Everyone cruising in the region is pretty much on the same schedule of activities. It helps to understand this customer environment when designing a network to properly handle the network traffic that will be generated. It also helps to understand it, when choosing a solution and provider(s).

Based upon modeling of the traffic using a resort type user base, the projections below are made:

| | | | | Growth/ |
|---|---|---|---|---|
| Ship Size | Counts | Now | | year |
| 1) Small Ship | 2000-2600 passengers, | 75 | Mbs | 15% |
| | 650 Crew, admin traffic | | | |
| 2) Medium Ship | 2601-3200 passengers, | 100 | Mbs | 15% |
| | 850 Crew, admin traffic | | | |
| 3) Medium Large | 3201-4000 passengers, | 150 | Mbs | 15% |
| | 1100 crew, admin traffic | | | |
| 4) Large Ship | 4001-5000 passengers, | 225 | Mbs | 15% |
| | 1400 crew, admin traffic | | | |

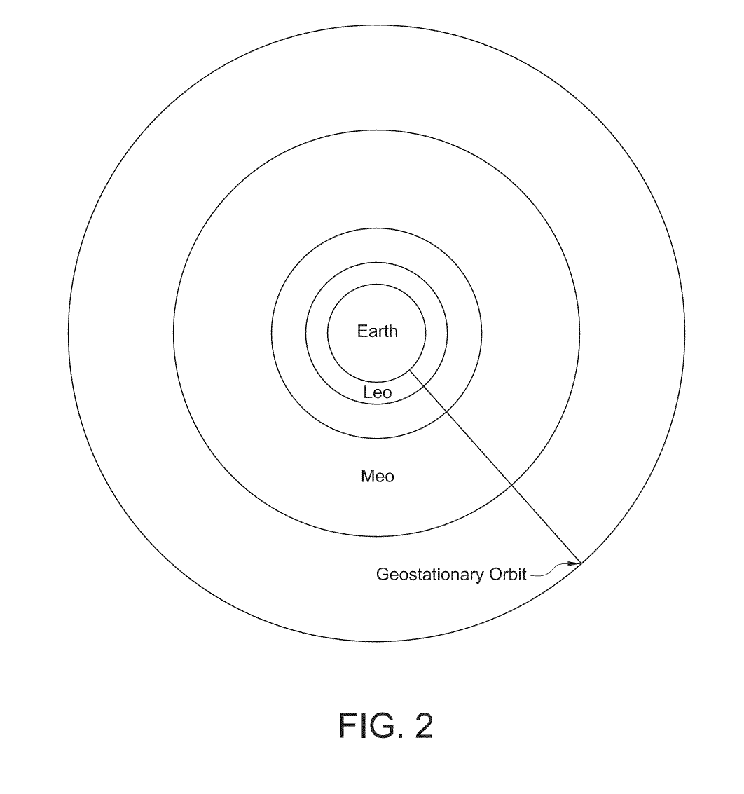

Second, let's look at the options to fulfilling the Internet demands described above (see FIG. 2).

GEO Satellite

This has been the answer to the cruise and maritime industry for a long time. The satellites being in an orbit that is synchronous with Earth's rotation causes the satellites to essentially remain over the same place on earth (see FIG. 2). They utilize a combination of wide beams and “spot” beams to send their signals to earth stations that are locked on the satellite's position. The recent use of “spot” beams from GEO satellites is a bit of a misnomer. A “spot beam” from 22,500 miles away is a pretty big spot. Usually 1000's of miles in size. The frequencies used on these satellites are C band, Ku band and more recently Ka band. While C band has the best propagation, as it is not affected by rain/snow or other weather, the bandwidth available is small resulting in connections with less than 1 Mbs of throughput. The Ku band suffers in very heavy weather conditions and has a lot of noise/interference around its bands. While a total of one GHz of bandwidth can be stitched together in this frequency, its normal applications have throughputs in the 4 to 8 Mbs range. The Ka band is very susceptible to heavy rain, snow or even heavy cloud cover. However, the bandwidth and performance are very high with throughputs exceeding 1 Gbs under optimal conditions. Unfortunately, a GEO solution is not the best orbit for overcoming the shortcomings of the Ka high frequency. There are some physics that come into play with higher frequencies. It takes significantly more amplification of Ka (due to its higher “loss over free air”) to make it to the ground stations with an acceptable signal level. When you add to this the need to have higher link margins to overcome the loss by rain, snow or clouds the amplification levels become quite significant. And with all amplifications comes more noise and distortion. While there are several mitigation techniques to help these transmissions, all require extra power and result in lower than optimal performance. So to sum up, the Ka obstacles in a GEO environment, the distance of 22,500 miles causes spot beams to be spread much larger dissipating signal energy, and clouds or other types of moisture in the air absorb some of the signal energy and reflect some as well. Therefore, it requires quite high amplification of the signal for an acceptable link margin, and high amplification causes signal distortion. This all results in a less than optimal performance of the Ka band.

All GEO systems that are in operation or announced are in the bent-pipe architecture (see FIG. 3). The bent-pipe and high altitude combine to make very large delays or latency in the data network. Generally, the latency on a GEO system is between 500 and 600 ms. This has a negative impact on network performance, and, while some mitigation techniques have been successfully deployed, the physics still remain, and this issue will become more pronounced as the Internet data and usage continue to mature.

Satellite Systems in GEO serving the Cruise Market

Global Xpress

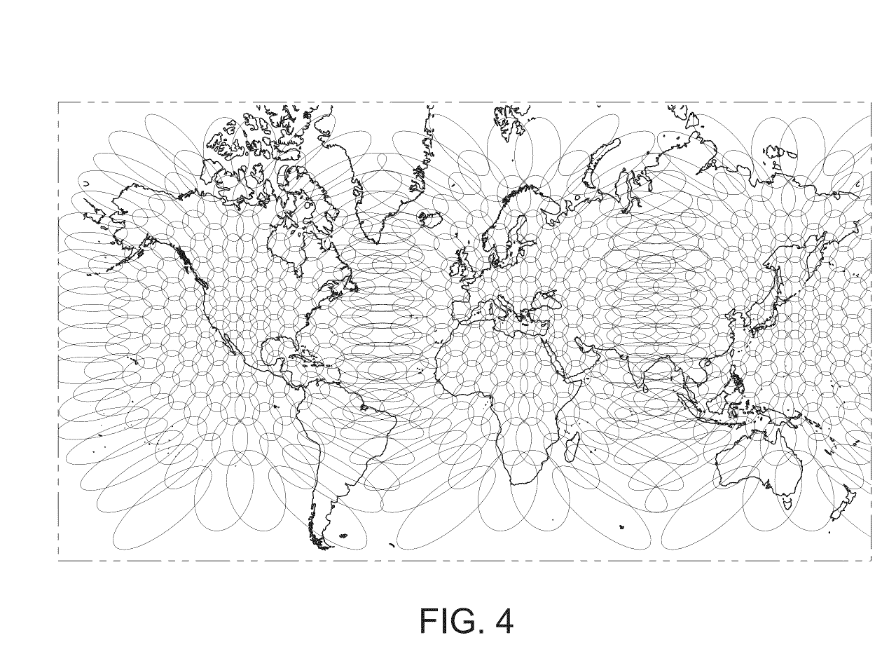

Inmarsat is currently launching its new Ka HTS named GLOBAL XPRESS. It promises bandwidth of 50 Mbs/5 Mbs over most of the earth excluding the Polar Regions. It is using 89 spot beams (72 concurrently) from each satellite of which there are three. (See FIG. 4) Each of these spot beams has 40 MHz of bandwidth available. While the satellites also have six steerable beams, these are intended for coverage under temporary circumstances such as natural disasters. GLOBAL XPRESS is using a “Bent Pipe Architecture” and couples the Ka with a fall back C band service. Since the Ka band is using fixed spot beams with frequency and polarization separation patterns to avoid self-interference, a mobile client will require equipment that has the ability to automatically change polarizations as necessitated by its movement. The data rates offered by this service are not sufficient to handle cruise ship traffic loads going forward (50 Mbs/5 Mbs). It is important to understand that the 40 MHz of the spot beam is going to be shared with all other clients in the same spot beam. So the 50 Mbs/5 Mbs is a shared data rate and CIR's would be significantly lower.

MEO Satellites

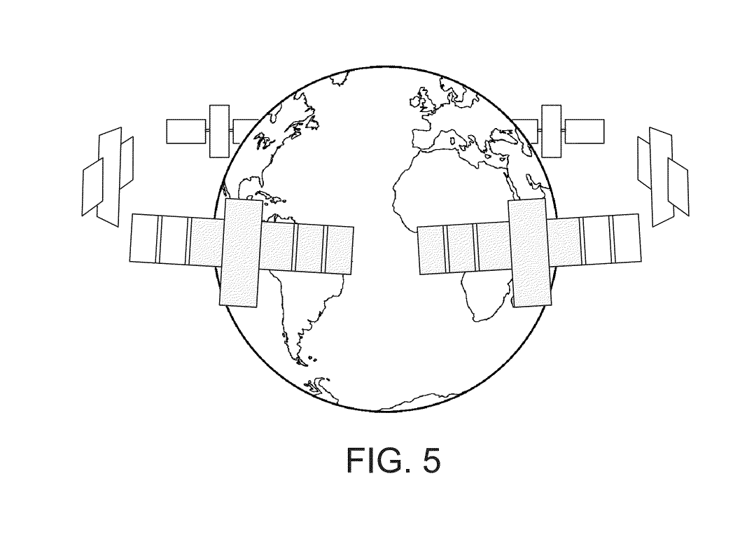

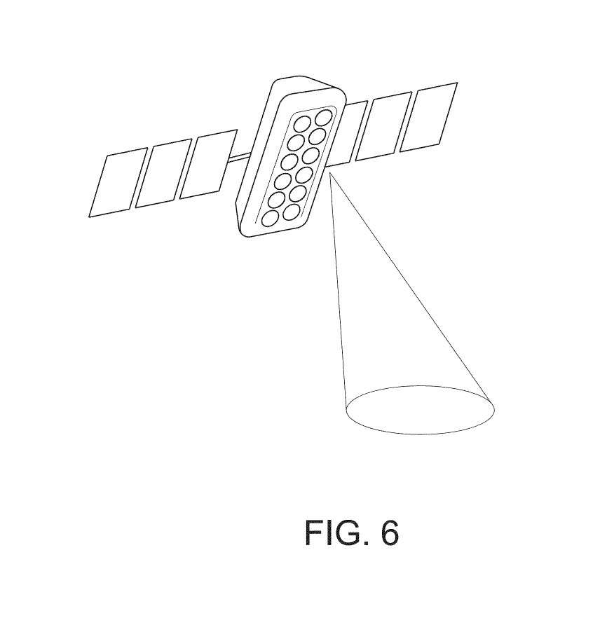

O3b has started launching satellites that will eventually make up an initial constellation of eight satellites arranged in an equatorial orbit (see FIG. 5). These satellites will be located at an altitude of 5,009 miles above the earth and equipped with Ka band radios using spot beam antennas. Their advertisements and collaterals describe their satellites as having 12 steerable spot beams with 2 used as their gateway beams. The marketing materials go on to state that each beam has a maximum bandwidth configuration of 1.2 Gbs. The 10 remaining client spot beams each have a coverage diameter of approximately 700 miles (see FIG. 6). While the 10 spot beams×1.2 Gbs would result in 12 Gbs of client data available, that does not accurately reflect the useable bandwidth. The two gateway spot beams of 1.2 Gbs each (2×1.2 Gbs=2.4 Gbs) would limit the maximum throughput that could be provided to the clients at any given time. Since O3b uses a “bent pipe” (see FIG. 3) architecture, which is to say there are no “inter-satellite” communications, there is no other way to get the client data off the satellite. Their Internet source gateway must also be within the “view” of the satellite in the region. Therefore, the 2.4 Gbs limitation would be for all clients within the 45° slice of the world that the individual satellite is covering at the time.

O3b's use of Ka is a better fit than the GEO's use of the technology, but still not optimal. While the distance is only ¼th the distance of the GEO, the rest of the issues remain.

The latency or delay on an MEO orbit system (see FIG. 2) is much better than the GEO, but still around 150 ms. For a reference, when network engineers are optimizing their networks for VoIP traffic, the rule of thumb is that the maximum delay must be below 150 ms for it not to be heard by the users. Latency or inter-packet delay will have detrimental effects on any network. Simply stated, the lower the latency, the better the network will perform.

MEO based satellite systems require at least two client stations per client location. The client stations on cruise ships must be four axis stabilized antennas with one waiting to pick up the new satellite on the horizon, while the other is connected to the servicing satellite. This allows for the second client station to “make” a connection prior to the first station “breaking” its connection. It would be advisable to have a third client station on standby, in the event of failure of either of the other two, since service would not be able to remain continuous with just one working. The antennas recommended by O3b are either a 1.2 m or a 2.2 m dish. It is expected that the larger ships with the greater bandwidth requirements would need the 2.2 m.

To adequately address the cruise market, O3b would have to redesign their satellites or add 28 more satellites to their constellation. O3b signed a contract to provide Royal Caribbean “Oasis of the Seas” with a 250 Mbs data connection. If they were to lower that commitment to 150 Mbs for the remaining ships, they would have to stop after 15 ships as this would exhaust their 2.4 Gbs of maximum throughput on their satellite, limited by the gateway links. During the season, there are approximately 76 cruise ships in the Bahamas/Caribbean on any given day. The way their orbits are set up, it is impossible to add more satellites to only a single area, but instead the entire constellation would have to be expanded to a point where there could be six satellites covering the area at a time to meet the demand. Even then this would only accommodate the ships and no other clients in that 45° of the world. This would obviously not be practical.

LEO Satellites—(LeoSat)

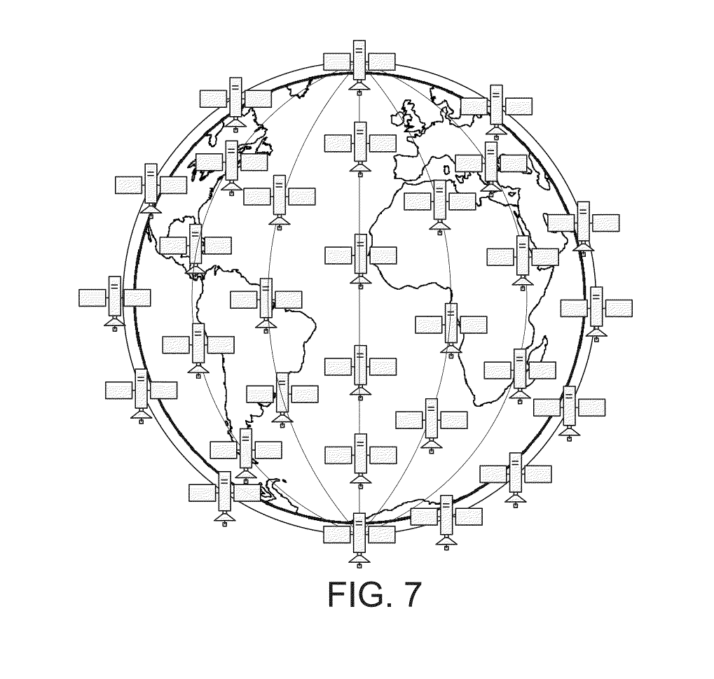

Iridium is the only operational LEO constellation that supports data at this time. But, their data is low bandwidth intended for messaging or possibly email. However, LeoSat is developing a system that will start service in approximately 35-38 months. It is being designed as a new generation of satellite networking. It will be used for comparison purposes here, as there is not currently a LEO system in operation that could meet the requirements of Cruise Ships. As with each of the systems, a LEO has some advantages and some challenges. With the satellites, less than 1100 miles above earth (see FIG. 2), the delays and radio power requirements are significantly more favorable for a LEO system. However, with such a short distance to earth the satellites have much smaller coverage areas. The Leo Sat system spot beams will be less than 450 miles in diameter, and it will take over 60 satellites to cover the world (see FIG. 7). Since the satellites have a much narrower view of earth, it is impossible to place a gateway in every location necessary to feed the satellites in a bent pipe architecture. Therefore, LeoSat will use Inter-Satellite Links (ISL's) that connect the satellites together in a communications network. Each satellite can exchange data with the satellite on either side, in front or back. This is in addition to its gateway links when it is over a gateway area. The LeoSat satellites are configured somewhat similarly to the O3b satellites, but with some significant modifications. The antennas are of a new design that do not require any moving parts. Each antenna can generate three electronically steerable beams, each with a Ka bandwidth of 1.2 Gbs. There are eight antennas on each satellite, and any beam can be a gateway or a client beam. This provides for any combination of the 24 beams between gateways and clients. The entire bandwidth of all beams can be transported off the satellite either via the gateway beams or the ISL's as necessary. There is full onboard routing on each satellite. There will be multiple satellites over a given area at a time providing for ample beams when there is a density of clients such as all the cruise ships in the Bahamas/Caribbean during the season. Each can have its own (not shared) bandwidth. The beams use coordinated frequency and polarization options across satellites to prevent self-interference.

The client stations for LeoSat's system utilize a new form factor for antennas that are flat panels measuring 50 in×50 in. There would be a set of four antennas. This configuration provides for redundancy and multiple satellite tracking at the same time. Each panel weighs approximately 22 lbs and can be pedestal or flat mounted. Connectivity to the equipment rack in the ship's data center can be via fiber or gigabit wired Ethernet. Power requirements are under 40 watts. There are no moving parts and therefore, no maintenance beyond periodic surface cleaning and connection maintenance.

The LeoSat system will be able to provide a ship up to 600 Mbs synchronous bandwidth with latency under 50 ms and have global coverage. The bandwidth on the satellite network is transported using a layer 2.5 of the OSI model (MPLS) so any form of encapsulation can be delivered natively. The network being completely open transport, allows for just about any technology to run in its native form across the network links. This greatly simplifies integration of different platforms for onboard services.

Terrestrial Based Networks

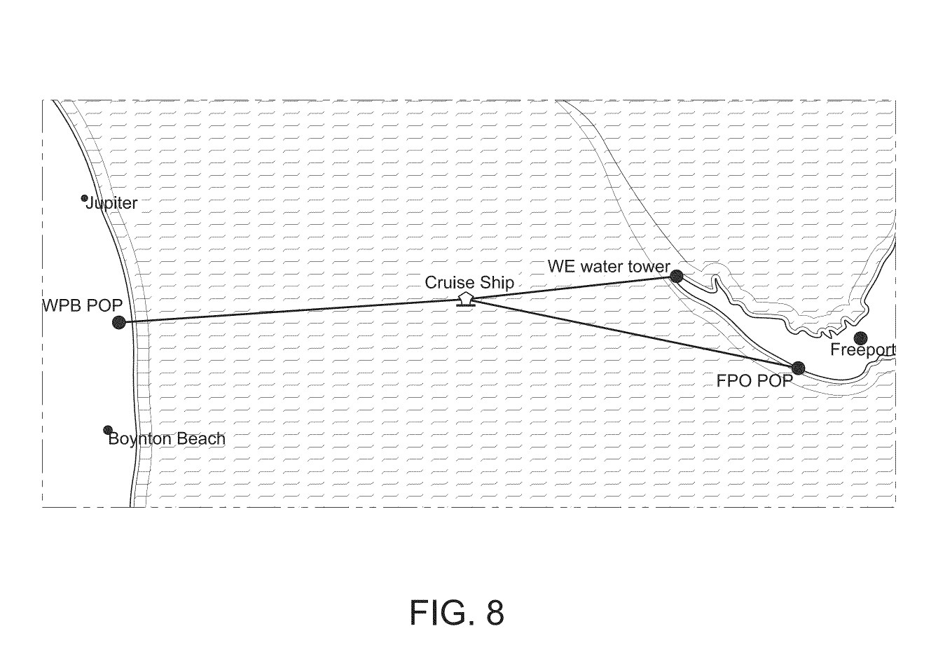

Even when the best satellite-based systems are in place and operating well, the use of terrestrial based systems in concert will be the most advantageous and efficient architecture with which to address this market. The terrestrial based systems (see FIG. 8) are always going to have a cost advantage. They will also be able to increase their performance at a better rate than the satellite offerings. There is no latency issues with terrestrial based system, and there are three systems in the market.

MTN-BATS

The BATS system is primarily a port based system for providing ships high bandwidth in ports and for a few miles of the approach of the port. The system consists of two small domed dish antennas that use the same type tracking mechanics as the satellite tracking dishes to focus on a port installed base station. While the system has a good throughput in port, it is very limited in range from the port. The typical range experienced is 20-25 miles before the connection starts dropping and throughput drops off.

The use of motorized dishes in domed pods is quite familiar to cruise lines, as well as the maintenance and repairs. Such systems just have too many moving parts, belts, motors and gears. There is wear, and very little wear can be tolerated by the systems before problems arise.

There is not much new or inventive about the BATS system, and it suffers from only having a single frequency band of operation. This will present significant problems in many ports with high noise levels. While some noise cancellation is possible, there are many times when the noise is just too great, and an alternate frequency is necessary.

Additionally, this system being limited to a single frequency usage at a time, will require ships to use a shared bandwidth connection with all other ships in the area using the same system. The ships are a concentrated connection and they should not be placed on contention based links which will be required by this system. Ships should not be “fighting each other for the same bandwidth”.

True Path

This system was originally designed to service aircraft while in flight with Wi-Fi based, data services from towers on the ground. After a patent dispute between several parties, some of the principals decided to look for other applications. It reports data rates of 50 Mbs at distances of up to 60 miles. However, this is under optimal conditions and would be very difficult to maintain over large expanses such as the routes in the Caribbean. This is due to the limited ability of placement of towers and facilities meeting their network requirements.

The system is more advanced than the previously mentioned BATS system, in that it uses phased arrays for its antenna systems. However, it is a much more complicated system to operate and the number of base stations and their critical placement for the proper functioning of the system would push costs quite high. This system uses similar methods as the next system in dealing with noisy environments or interference. However, it is also limited to a single frequency band which will limit its performance in many of the noisy locations. Especially, if the ISM bands are used. The lack of the ability to be frequency and polarization agile when dealing with the major ports of the world is a major drawback. Further the use of only a single frequency band and single radio per base station means all ships in an area will be sharing the same bandwidth of the base station. Cruise ships are already very concentrated and should never be put in a contention based network environment.

IT Centricity

IT Centricity's system seems the most advanced and has addressed many of the issues the other systems have not yet moved on. It has frequency and polarization agility that is automated for use anywhere in the world. The system has several levels of redundancy to ensure operational uptime. IT Centricity's system has the following characteristics:

| | |
|---|---|
| Distance/Reach | Typical up to 60 miles from shore. |
| | (With enough base |
| | station height, up to 100 miles) |
| Redundancy | Includes six combinations of frequencies, |
| | polarizations and channels. |
| | This means each ship gets its own |
| | non-contention |
| | dedicated bandwidth. |
| Interference | Automated system selects best-performing |
| | available combination anywhere |
| | in the world. Beam forming |
| | methods using null beams for cancellation. |
| Regulatory | Automatically adjusts or turns on and off |
| Compliance | radios/amplifiers based on GPS location |
| | and regulatory requirements. |
| Congested Ports | Automatically assigned individual |
| | combination providing a |
| | dedicated link(s). A major differentiator. |
| Install Difficulty | Requires 1.5 days of good weather for |
| | system to be completed. |
| Maintenance | Leased system with all service and |
| Fees | parts the responsibility |
| | of ITC. No moving parts. |
| Available | Multiples of 20 Mbs. |
| bandwidth | |
| Routing | Flexibility, VPN, redirection, DNS |
| | based return access. |
| Extra Features | Full detailed usage reporting, phone s |
| | ervices available, turnkey, service |
| | classes, redundancy and spare parts on |
| | each ship, auto-switcher, combiner for data. |
| System Monitoring | System is monitored in real |
| | time from central NOC. |
| | Proactive performance intervention |
| | when necessary. Full remote access with |
| | immediate change deployments. |
| Performance | Up to 108 Mbs with 5-8 ms latency. |
| | Bandwidth is provided using multiple |
| | links assigned by a centralized system. The |
| | central system has a view of all |
| | ships in the area and ships that will be arriving |
| | in the area. Bandwidth, frequencies, |
| | polarizations and channels are determined |
| | by ship reporting signal readings and the central |
| | system allocating resources. This keeps ships |
| | from competing for or having to share |
| | links. |

The system provides for consistent performance and coverage based upon the ship's tracks. The system can accurately forecast coverage on a current sailing based upon previous sailings and the current track. This includes when the ship approaches a non-coverage area, and how long it will be before the ships are back in coverage. This information is readily available on the ship and can be displayed on the “sign-on” or “log-on” page. Based on historical itinerary tracks, ships are in coverage areas 68-72% of the time.

Summary (table)

### GEO Satellites (Geosynchronous Earth Orbit, see FIG. 2)

PRO's: 1) Wide coverage area.
2) C band, Ku band and Ka band offerings
3) The most reliable performance with C band.
4) Most widely available.

CON'S: 1) High amplification required, hurts performance.
2) Latency of 500-600 ms causes poor data performance
3) Most difficult for Ka due to link budget requirements and client stations
4) Interference in ports from noise

### MEO's (Medium Earth Orbit, see FIG. 2)

PRO's: 1) Improved performance through lower latency at 150 ms
2) Better orbit for Ka band
3) High throughput to select clients 1.2 Gbs
4) Well suited for telecom back haul

CON's: 1) Serious limit of throughput on satellite
2) Expensive to expand capacity
3) Does not have world-wide coverage
4) Requires expensive tracking client stations with very active moving parts

### LEO (Low-Earth Orbit, see FIG. 2)

PRO's: 1) Best performance with very low latency at under 50 ms
2) Best orbit for Ka band due to the ability to deliver high link budget, overcoming rain fade.
3) True high-throughput worldwide solution
4) Low cost, low maintenance client stations. No moving parts
5) Redundancy designed into the constellation

CON's: 1) 36 months away

### Terrestrial Base System (IT Centricity)

PRO's: 1) Lowest latency under 10 ms
2) Automated multiple frequencies and options
3) Good throughput with up to 100 Mbs
4) No cost to cruise lines for system
5) Ability to be aggregated with satellite services

CON's: 1) Coverage limited to 60-100 miles from shore
2) Requires a satellite system to make complete solution
3) Some locations will have better performance due to source availability

Internet access for cruise ships is currently a need and will continue down the path of being more and more a necessity. It needs to be as robust and as available as it is in resorts today. After all, that is where the competition is. The difficulties of obtaining robust Internet on a cruise ship is of little concern to the passenger. They just want their digital life to continue as normal while on their vacation. This means always on and being able to download and upload at will. And while this will be challenging for the industry, solutions are on the way and some here today.

A hybrid system will be best to meet the demand and needs. Using a satellite-based system is the only way to get the ubiquitous coverage necessary, but costs and performance will direct the cruise line to the use of the terrestrial provider in concert with the satellite system.

The cost of the terrestrial system will always be less than the cost of satellite bandwidth. So not to use it where it is available would seem to leave a valuable cost effective tool out of the tool box for addressing the needs. The terrestrial system must play nice with the satellite system and the switching that occurs between the systems must be invisible. The bandwidths should be aggregated to improve overall performance and take some of the load off the satellite system when available. Today's usage includes a good bit of data traveling up as pictures and other posts are sent regularly from phones, tablets, and laptops. Interactive games also require significant up speeds.

Cruise ships are a very concentrated client and as described herein, schedules of use are somewhat aligned. This does not lend itself to the use of a non-dedicated bandwidth from a supplier. Using a shared bandwidth model from a provider would not be a good choice.

While each system should be measured individually for contractual compliance, the aggregated bandwidth should be used to meet the ships many requirements. Some activities can be planned so as to improve the chances that they occur during the augmented periods, and this will help with overall performance. Large file uploads are going to work best on a fully synchronous terrestrial based connection. If those uploads occur to the same or a group of locations, this can be routed appropriately by the system.

It would also be best to manage the crew access time to coincide with periods where there is the added bandwidth of the terrestrial system to cover the load. This will assist in keeping the crew usage from contention with the passenger usage.

For a ship to send everything over their satellite connection and not have an alternative or augmentation would seem to be a system that will have periods of contested performance and some outages. Satellites are good and getting better, but no one offers five nines guarantees on satellite services today. The terrestrial link is an additional less-expensive bandwidth in good times and a backup system in bad times. Either way a tool that is necessary in the toolbox to address the solution.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

We claim:

1. A system for routing data between ground-based networks and satellites as shown and described herein.

2. The system of claim 1 further comprising synchronous bandwidth.
